(19) United States
(12) Patent Application Publication
(10) Pub. No.: US 2018/0254917 A1
(43) Pub. Date: Sep. 6, 2018

(54) MIGRATION BETWEEN ACCESS SERVICES

(71) Applicant: ADTRAN GmbH, Berlin (DE)

(72) Inventors: Uwe Schmidtke, Greifswald (DE); Martin Kuipers, Dallgow-Doberitz (DE); Nils Asmusssen, Berlin (DE)

(21) Appl. No.: 15/908,564

(22) Filed: Feb. 28, 2018

(30) Foreign Application Priority Data
Mar. 1, 2017 (DE) DE102017104242.3

(51) Int. Cl. H04L 12/28

(52) U.S. Cl. CPC H04L 12/2867; H04L 12/2858

(57) ABSTRACT

A method is suggested for switching a subscriber line, the method comprising (i) conducting an evaluation of a signal provided by a terminal device, and (ii) controlling a switch that is arranged to connect one of at least two access services based on the evaluation of the signal with the subscriber line that is connected to the terminal device. Also, corresponding systems are provided.

### CROSS REFERENCE TO RELATED APPLICATION

This application claims priority to German Patent Application No. 10 2017 104 242.3, entitled “Migration Between Access Services” and filed on Mar. 1, 2017, which is incorporated herein by reference.

### BACKGROUND

Embodiments of the present invention relate to a migration between access services, in particular to switching of a subscriber line from one access service of a telecommunication network to another.

### SUMMARY

A first embodiment relates to a method for switching a subscriber line. The method comprises conducting an evaluation of a signal provided by a terminal device. The method also comprises controlling a switch that is arranged to connect one of at least two access services based on the evaluation of the signal with the subscriber line that is connected to the terminal device.

A second embodiment relates to a system that comprises a migration unit and a first access node providing a first access service via the migration unit. The system also comprises a second access node providing a second access service via the migration unit, and the migration unit comprises a switch that is arranged to connect one of the access services with a subscriber line that is connected or connectable to a terminal device. The first access node is arranged to conduct an evaluation of a signal obtained via the subscriber line and to control the switch based on the evaluation of the signal.

A third embodiment relates to a system that comprises a first access node providing a first access service to a migration unit. The system also comprises a second access node providing a second access service to the migration unit, and the migration unit comprises a switch that is arranged to connect one of the access services with a subscriber line that is connected or connectable to a terminal device. The system further comprises a network management system that is connected to the first access node and to the second access node. The network management system is arranged to conduct an evaluation of a signal obtained via the subscriber line and control the first access node to control the switch based on the evaluation of the signal.

A fourth embodiment relates to a computer program product that is directly loadable into a memory of a digital processing device, comprising software code portions for performing the steps of the method as described herein.

A fifth embodiment relates to a computer-readable medium which has computer-executable instructions adapted to cause a computer system to perform the steps of the method as described herein.

### BRIEF DESCRIPTION OF THE DRAWINGS

Embodiments are shown and illustrated with reference to the drawings. The drawings serve to illustrate the basic principle, so that only aspects necessary for understanding the basic principle are illustrated. The drawings are not to scale. In the drawings the same reference characters denote like features.

FIG. 1 shows an exemplary diagram visualizing the situation without a migration Circuit.

FIG. 2 shows a schematic diagram that allows for an automatic migration to a G.fast service.

FIG. 3 shows an example of an automatic migration that involves a Network Management System (NMS) for evaluating the type of the CPE.

### DETAILED DESCRIPTION OF THE PREFERRED EMBODIMENTS

Examples described herein allow for an automatic migration process from a first telecommunication service to a second telecommunication service, e.g., from an Central Office or cabinet launched xDSL service to a DPU-based G.fast service (or vice versa). The approach reduces migration efforts of the provider and is also convenient for the end user.

xDSL (also referred to as DSL) is a family of technologies that provide digital data transmission over the wires of a local telephone network.

Advantageously, the examples provided herein enable the migration from an existing DSL service to a newly available G.fast service without operator activities. An installation at the customer's premises may be conducted by the end-user (self-installation). It is in particular an advantage that the end user may trigger the automatic migration by simply connecting a device, e.g., a CPE. This new device may be compatible with the newly available G.fast service.

Data transmission via copper-based access networks is facilitated via xDSL based on ITU-T specifications G.99x.y. Newly available G.fast services may be implemented based on ITU-T specifications G.9700 and G.9701.

G.fast provides higher data rates compared to xDSL. Hence, in a basic use case scenario, the end user wants to migrate from DSL to G.fast as easy and with as few interruptions as possible.

High data rates may be based on short subscriber lines. Hence, the migration towards G.fast may require a change of the CPE as well as a change of the network topology.

ITU-T specification G.994.1 describes methods for detecting and aligning the capabilities of the devices that are connected to the line. These methods may be utilized for migration purposes.

The network operator provides xDSL services that are supported by an Access Node (AN) located in the Central Office (a building) or in a cabinet (in the street). The AN may also be referred to as DSLAM or MSAN.

A new service might be deployed via ANs that are referred to as Distribution Point Units (DPUs), which support G.fast on the existing copper wires. The DPU may be deployed at a location different from the existing AN. For example, the DPU can be deployed in a basement of a building as Fiber to the Building (FTTB), in an outside Distribution Point as Fiber to the Distribution Point (FTTDP) or in an outside Cabinet as Fiber to the Cabinet (FTTC).

When the end user subscribes to the new service the subscriber line (a pair of copper wires) need to be rewired or switched from the existing AN (a DSLAM) to the new AN (a DPU). Also, the end user needs a CPE (Customer Premises Equipment) that is capable of utilizing this new service.

If the installation is done by the user (self-installation), the time when the user is connecting the new equipment is not known to the operator. However, the end user would like to obtain a seamless transition without having to wait long for the new service to be available. However, an immediate and direct interaction between the end user and the operator to switch from the old to the new service might be difficult.

On the other hand, an installation conducted by the operator for every single subscriber at a different time increases the overall installation costs.

As there is crosstalk between wire pairs of a cable (the cable comprising several subscriber lines, i.e. wire pairs), such crosstalk has to be considered if the migration is conducted line by line. If there are only either (vectored) VDSL2 (G.993.5) lines or only G.fast lines in the cable, the far-end crosstalk can be cancelled by using vectoring technology. However, this does not work between G.fast and (vectored) VDSL2 lines. These two technologies need to be separated by using different frequency ranges, e.g., VDSL2 running at up to 17.6 MHz and G.fast starting above 17.6 MHz. Even with such a separation of the frequency ranges, additional means to reduce mutual interference may become necessary.

Known approaches to conduct such migration involve high efforts and costs.

First, the installation may be done manually by technicians on-site. In this case, the technician conducts the installation at the end user's side of the subscriber line, then moves to the DPU connection point to switch the line from the previous AN (DSLAM) to the new G.fast DPU.

Second, the end user conducts the installation (also referred to as self-installation) then contacts the operator to switch the service: The operator may have to send a technician to the copper connection point to switch the copper pair.

Both options are inflexible, require a technician moving to the end user and/or to the access node. Hence, these solution would result in a delay, longer service interruptions as well as significant costs.

Examples described herein provide a framework for migrating a subscriber line without the necessity of manual intervention. The migration may be from an existing xDSL service (e.g., ADSL2 or VDSL2) to a new service (e.g., G.fast). The new service may be supplied by an AN that is at a different location as the previous AN. In many cases, the new AN may be closer to the CPE.

Hence, an equipment (hereinafter also referred to as DPU which may comprise a migration functionality) providing the new service is connected at a certain point of the existing subscriber line with a switch (e.g., a relay) that can also detach the subscriber's line from the old equipment (e.g., DSLAM).

The switch may ensure that the communication between the old CPE and the DSLAM is still feasible. If the DSL CPE is replaced by a G.fast CPE, the subscriber line can automatically be switched to the DPU. An detection entity (e.g., DPU or NMS) may therefore evaluate the detected type of CPE and it may trigger the switching of the subscriber line accordingly.

In such scenario, no interaction with an operator is required. The trigger for automatically migrating the service may be the connection of the CPE. This is also backward-compatible, i.e. the new CPE can be replaced by the old CPE: The old CPE is detected and the switching back to the DSL CPE is initiated. The end user does not have to experience an significant interruption of the service. A simple replacement and a reconnection procedure is sufficient. Also, the end user has the flexibility to decide when to migrate. Also, if something does not work, the end user can easily go back to the previous service. Hence, the migration thus becomes flexible, simple and efficient.

### DPU Based Migration

As an example, a monitoring function may be provided by the DPU. This monitoring function may analyze a handshake process between the CPE and the existing DSLAM. Once the DPU detects a G.fast capable CPE it switches the subscriber line to its G.fast interface. Next, the G.fast service can be established via a handshake between the DPU and this CPE.

The monitoring function may not impact the handshake process between the DSLAM and the DSL CPE. It may in particular be arranged to evaluate the information sent by the CPE thereby indicating the capabilities of the CPE. Depending on this information (conveying the capabilities of the CPE), the DPU may decide which service to use and whether to switch the subscriber line between DPU and CPE or DSLAM and CPE.

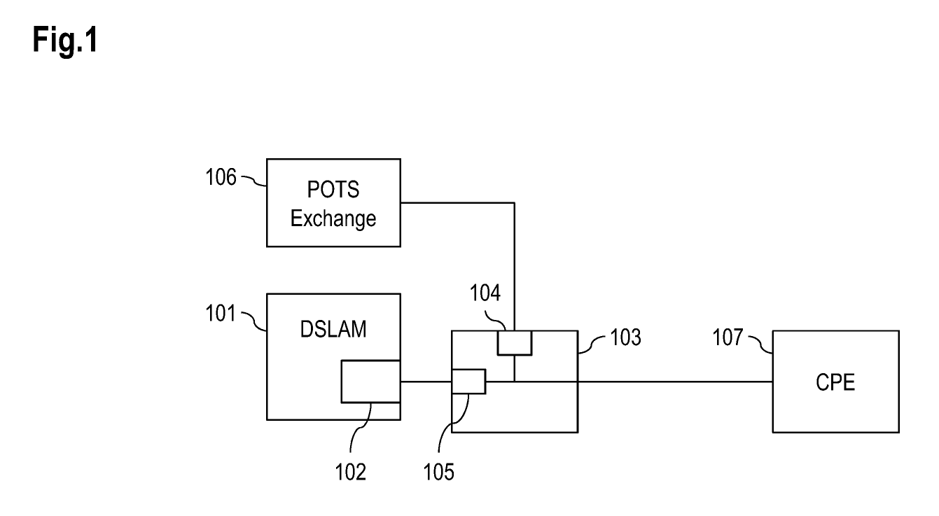

FIG. 1 shows an exemplary diagram visualizing the situation without a migration circuit. An existing xDSL service is supplied by an xDSL transceiver 102 of a DSLAM 101. The DSLAM 101 is connected to a splitter 103 via the xDSL transceiver 102. Also, a POTS exchange 106 providing POTS (telephony services) is connected to the splitter 103.

The splitter 103 is a “xDSL over POTS” splitter, i.e. the connection from the POTS exchange 106 is connected to a low pass filter 104 of the splitter 103 and the connection from the DSLAM 101 is connected to a high pass filter 105 of the splitter. The splitter is further connected to a CPE 107.

In this example of FIG. 1, ADSL2 or VDSL2 over POTS are supplied towards the CPE 107. It is noted that any other xDSL service with or without POTS can be supplied to the CPE 107. The DSLAM 101 may be located in a central office (CO) or in a cabinet that is placed close to the CPE 107.

The low pass filter 104 ensures that merely frequencies of the POTS are conveyed towards the PTS exchange 106 and the high pass filter 105 ensures that merely frequencies of the xDSL service are conveyed towards the DSLAM 101.

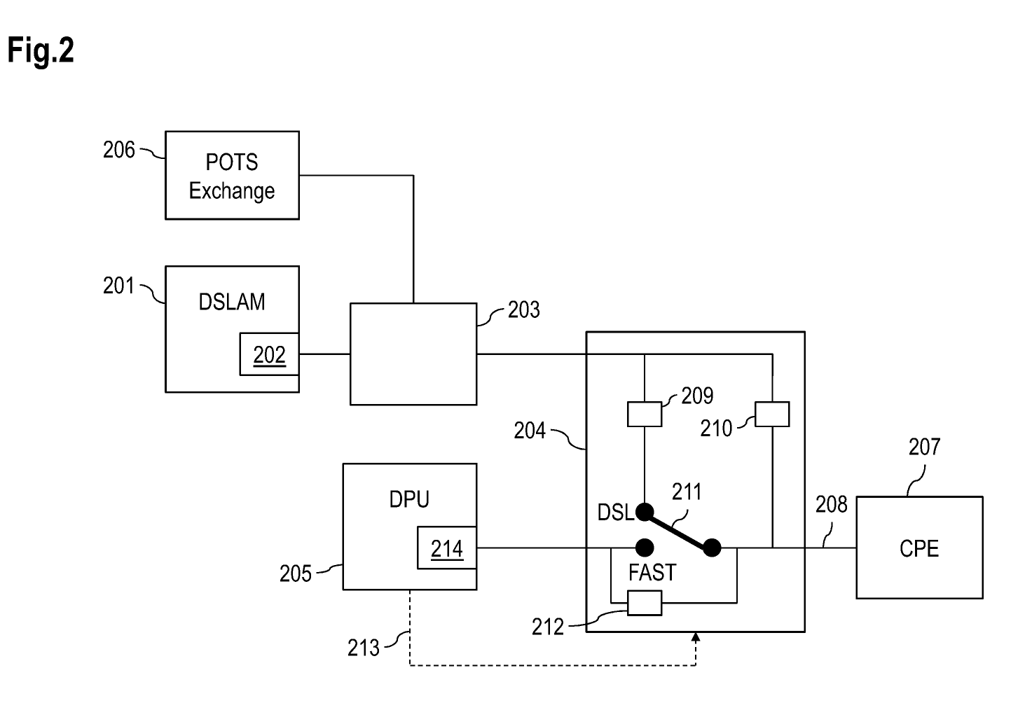

FIG. 2 shows a schematic diagram that allows for an automatic migration to a G.fast service.

An existing DSL service is supplied by an xDSL transceiver 202 of a DSLAM 201. The DSLAM 201 is thereby connected to a splitter 203. Also, a POTS exchange 206 providing POTS is connected to the splitter 203.

The splitter 203 is a “xDSL over POTS” splitter. The splitter is further connected to a migration circuit 204. The splitter 203 may be comparable to the splitter 103 as shown in and described with regard to FIG. 1.

A G.fast service is supplied by a DPU 205, which is also connected to the migration circuit 204. In an embodiment, the migration circuit may also be part of the DPU.

The migration circuit 204 is connected via a subscriber line 208 to a CPE 207. The CPE 207 may be an xDSL CPE or a G.fast CPE. In other words, the CPE 207 may be of the xDSL type or of the G.fast type. Depending on the type of the CPE 207, the capabilities are different. As described above, the capabilities of the CPE 207 can be detected thereby determining the type of the CPE 207 that is connected to the subscriber line 208.

The splitter 203 is connected to a DSL low pass filter 209 and to a POTS low pass filter 210, which are both part of the migration circuit 204. The output of the DSL low pass filter 209 is connected to a DSL terminal of a switch 211. The output of the POTS low pass filter 210 is connected to an output of the migration circuit 204, which is connected to the subscriber line 208. The cutoff frequency of the POTS low pass filter 210 is such that it passes the telephone signal but not the xDSL signal while the DSL low pass filter 209 may pass signals up a maximum frequency used by the xDSL service.

The DPU 205 comprises a G.fast transceiver 214 that is connected to the migration circuit 204, in particular to a G.fast terminal of the switch 211. This G.fast terminal of the switch 211 is connected via a HS filter 212 to the output of the migration circuit 204.

The switch 211 is able to switch either the DSL terminal or the G.fast terminal to the output of the migration circuit 204. The switch 211 can be controlled by the DPU 205, which is indicated by a dashed switch control line 213. The switch 211 may be any electronic switch (transistor, relay, microcontroller) that could be controlled via a signal. The control may be realized by in-band or out-band signaling. The switch control line 213 may be a separate connection or it may be a logical connection realized by the already existing connection between the DPU 205 and the migration circuit 204.

It is noted that the migration circuit 204 may be a separate unit or it may (at least partially) be integrated with the DPU 205.

The migration circuit 204 may operate as follows.

The DSL low pass filter 209 comprises a low-pass filter that suppresses DSLAM signals above a frequency range that is used for DSL subcarriers. This may be beneficial for a coexistence of DSL and G.fast in the access network. Depending on the crosstalk and the used frequency ranges, due to its out of band emissions the DSLAM 201 may otherwise disturb G.fast signals at neighboring lines of the DPU 205 or the CPE 207. Such crosstalk may occur if subscriber lines with DSL services and subscriber lines with G.fast services share the same cable.

It is noted, however, that the DSL low pass filter 209 may be omitted. In this case the splitter 203 is electrically connected to the DSL terminal of the switch 211.

It is another option to provide additional or different filters. For example, in case of coexisting G.fast/VDSL2 services, it may be beneficial to implement additional filters in other parts of the setup: For example, a low pass filter at the DSL CPE 207, a high pass filter at the DPU 205, a high pass filter at the G.fast CPE 207 (it is noted that the CPE 207 can be either a DSL CPE or a G.fast CPE).

The POTS low pass filter 210 ensures that the POTS can still be used when the DSL service is replaced by the G.fast service. Hence, this POTS low pass filter 210 allows for POTS signals to pass towards the POTS exchange 206, but blocks high frequency G.fast signals.

The HS filter 212 passes (intercepts) G.994.1 handshake communication between the CPE 207 and the DPU 205 or between the DSLAM 201 and the DPU 205. As long as the switch 211 connects the subscriber line 208 to its DSL terminal, the CPE 207 is switched to the DSLAM 201. In this case, the G.994.1 handshake occurs between the CPE 207 and the DSLAM 201. The HS filter 212 (which may be part of the DPU's handshake-monitoring circuit) does neither disturb these handshake signals nor the DSL signals. Beneficially, the input impedance of the HS filter 212 towards the subscriber line is sufficiently high in the respective frequency ranges during the respective phases (handshake, training, showtime) of the communication between the CPE 207 and the DSLAM 201.

The switch 211 connects the subscriber line 208 either to the DPU 205 (via the G.fast terminal of the switch 211) or to the DSLAM 201 (via the DSL terminal of the switch 211). The switch 211 is controlled by the DPU 205 and the switching state of the switch 211 may depend on the capability of the CPE 207 and (optionally) on settings supplied by the management system of the DPU 205.

If the DSLAM 201 is connected to the subscriber line 208, the DPU 205 (via the HS filter 212) monitors the handshake between the CPE 207 and the DSLAM 201. If the DPU 205 is connected to the subscriber line 208, the handshake takes place between DPU 205 and the CPE 207. In either case, the DPU 205 is able to detect the type (e.g., xDSL or G.fast) of the CPE 207 and is thus able to set the switch 211 to the required position.

### NMS Based Migration

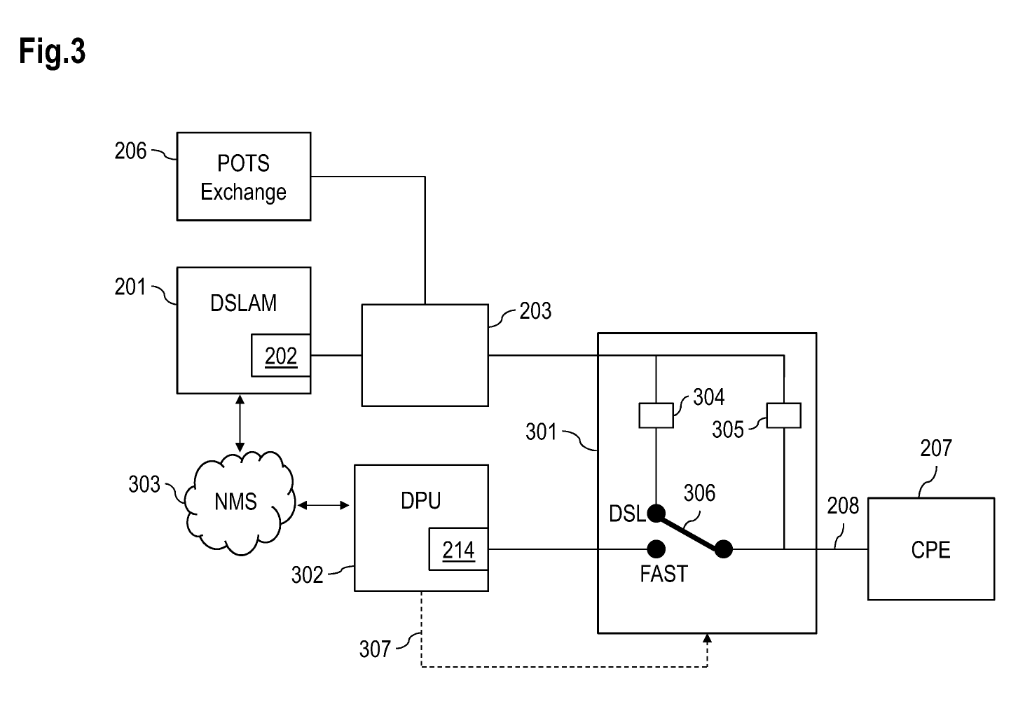

FIG. 3 shows an example of an automatic migration that involves a Network Management System (NMS) 303 for evaluating the type of the CPE 207.

FIG. 3 shows the POTS Exchange 206, the DSLAM 201 with the xDSL transceiver 202, the splitter 203, the subscriber line 208 and the CPE 207 of FIG. 2.

The migration circuit 204 is replaced by a migration circuit 301, which comprises a DSL low pass filter 304, a POTS low pass filter 305 and a switch 306. These components of the migration circuit 301 are similar to the components shown in and explained with regard to FIG. 2. The switch 306 is able to connect either its DSL terminal or its G.fast terminal to the output of the migration circuit 301. The output of the migration circuit 301 is connected to the subscriber line 208.

The switch 306 is controlled via a DPU 302, which is connected to the migration circuit 301, in particular to the G.fast terminal of the switch 306. Such control of the switch 306 is indicated by a dashed switch control line 307. The switch 306 may be any electronic switch that could be controlled via a signal. Such control may be realized by in-band or out-of-band signaling. The switch control line 307 may be a separate connection or it may be a logical connection realized by the already existing connection between the DPU 302 and the migration circuit 301.

The NMS 303 communicates with the DSLAM 201 and with the DPU 302. In particular, a NMS 303 may be provided for the DPU 302 as well as for the DSLAM 201.

In contrast to FIG. 2, no handshake monitoring functionality is required to be utilized by the DPU 302. The type information of the CPE 207 can be obtained from information exchanged during normal handshake, either between the DSLAM 201 and the CPE 207 (if the switch 306 connects the DSL terminal to the subscriber line 208) or between the DPU 302 and the CPE 207 (if the switch 306 connects the G.fast terminal to the subscriber line 208). Hence, the type information of the CPE 207 can be determined either by the DPU 302 or the DSLAM 201. This type information of the CPE 207 can hence be forwarded to the NMS 303 (or the NMS 303 may actively pull this information).

If the NMS 303 does not have reliable (or any) type information from or for a particular CPE 207, the NMS 303 may try commencing initialization of the subscriber line using a specific (e.g., predefined or alternating) position of the switch 306. This may in particular be helpful if the status of the CPE installation is unknown or to resolve pervious link initialization failures.

### Exemplary Migration Procedure

An exemplary migration may comprise at least one of the following steps:
1) A provider installs a G.fast DPU 205, 302 and a migration circuit 204, 301. A default switch position of the switch 211, 306 is set to its DSL terminal, which connects the CPE 207 to the DSLAM 201.
2) The end user may replace the CPE 207, i.e. the DSL-type CPE is replaced with a G.fast capable CPE.
3) After being connected, the G.fast-type CPE 207 tries a handshake with the DSLAM 201.
   According to the example shown in FIG. 2, the HS filter 212 allows the DPU 205 to determine that the CPE signaled that it is G.fast capable and the DPU 205 controls the switch 211 via the switch control line 213 such that the switch 211 is set to connect its G.fast terminal to the subscriber line 208.
   According to the example shown in FIG. 3, the initialization will fail, if the G.fast-type CPE 207 is connected to the DSLAM 201. However, the DSLAM 201 obtains the capabilities of the CPE 207. The NMS obtains the capability information of the CPE 207 and determines based on this information that the CPE 207 is a G.fast capable CPE. The NMS 303 may further inform the DPU 302 to switch the switch 306 to the G.fast terminal. If the NMS 303 cannot retrieve the CPE's abilities, it may trigger a temporarily change of the position of the switch 306 to try the initialization with another service, e.g., G.fast.
4) If the user replaces the G.fast-type CPE with a DSL-type CPE, the CPE 207 will start its handshake process with the G.fast DPU 205, 302.
   According to the example shown in FIG. 2, the initialization fails if the CPE 207 is a DSL-type CPE, which is not G.fast capable. However, the DPU 205 can determine the DSL capability of the CPE 207 via the HS filter 212 and control the switch 211 (via the switch control line 213) to switch from the G.fast terminal to the DSL terminal. If the DPU 205 cannot retrieve the type of the CPE 207, it may temporarily change the position of the switch 211 to try an initialization with another service, e.g., DSL.
   According to the example shown in FIG. 3, the initialization fails if the CPE 207 is a DSL-type CPE, which is not G.fast capable. The DPU 302 may obtain the type information of the CPE 207 and convey this information to the NMS 303. The NMS 303 instructs the DPU 302 to change the position of the switch 306. This can be achieved by the DPU 302 via the switch control line 307. If, however, the DPU 302 cannot retrieve the type of the CPE 207, the NMS may instruct the DPU 302 to temporarily change the position of the switch 306 to try an initialization with another service, e.g., DSL.

Examples described herein allow for an automatic migration to a new service. It is, however, also possible to switch back to a legacy service. Both can be achieved without manual interaction. It is an option to automatically switch between services with or without involvement of the NMS.

Both components, DSLAM and DPU, may preferably be configured to provide a service (xDSL, G.fast) to the subscriber (i.e. the end user's subscriber line). If the end user connects a G.fast CPE while the user has not yet subscribed to the G.fast service and if the DPU has not been configured to provide the G.fast service, the initialization may fail regardless of the state of the switch. In such scenario it may be beneficial to lock or enable the switching capabilities. This may be administered and/or monitored by the NMS. This locking/enabling may be utilized accordingly once the migration is conducted and the old service has been turned off.

The examples suggested herein may in particular be based on at least one of the following solutions. In particular combinations of the following features could be utilized in order to reach a desired result. The features of the method could be combined with any feature(s) of the device, apparatus or system or vice versa.

A method is provided for switching a subscriber line. The method comprises conducting an evaluation of a signal provided by a terminal device, and controlling a switch that is arranged to connect one of at least two access services based on the evaluation of the signal with the subscriber line that is connected to the terminal device.

The evaluation of the signal may be directed to any signal supplied by the terminal, e.g., a CPE. However, the evaluation of the signal may also refer to a signal that is expected but not received. For example, the absence of a signal may be used to control the switch, either by connecting to another access service or by maintaining the current position of the switch.

The switch may be an electronic switch that is arranged to select one out of several, in particular out of two, connections. The connection selected determines the access service that is connected to the terminal device.

In an example, the at least two access services are exactly two access services. The switch is then arranged to toggle between connecting one or the other access service to the terminal device.

The access service may be supplied by an access node (AN).

The signal that is subject to the evaluation may be a handshake signal or a signal of a handshake process for initializing a communication between the terminal device and the access service.

In an embodiment, the terminal device is a customer premises equipment.

In an embodiment, one of the at least two access services is a G.fast service.

In an embodiment, one of the at least two access services is an xDSL service.

In an embodiment, the signal provided by the terminal device is a signal of a handshake process between the terminal device and a device supplying one of the at least two access services.

The device supplying the access service may be an access node. The access node may be a DSLAM or a DPU.

In an embodiment, the signal of the handshake process identifies the access service and the switch is controlled such that the access service is selected that corresponds to the signal of the handshake process.

In an embodiment, the switch is controlled such that it changes its current switching state in case conducting the evaluation of the signal did not reveal an access service to be selected.

Hence, the switch may be toggled in case no access service could be determined based on the evaluation of the signal.

In an embodiment, conducting the evaluation of the signal is processed at a first access node that supplies a first access service.

The first access node may be a DPU that is arranged to supply the G.fast service or any other new service that is subject to an upgrade or migration.

In an embodiment, the switch is bypassed via a handshake filter that is connected to a terminal of the switch that is connected to the first access node and wherein the first access node is arranged to conduct the evaluation of the signal based on the output provided by the handshake filter.

In an embodiment, at least one additional terminal of the switch is connected towards a second access node, wherein the switch is arranged to be switched between the terminal and the additional terminal.

In an embodiment, the first access node is a distribution point unit.

In an embodiment, the first access node supplies a G.fast service.

In an embodiment, the second access node is a DSLAM, which in particular provides an xDSL service.

In an embodiment, the first access node is arranged to control the switch.

The switch is controlled such that it connects one of its terminals to a subscriber line that is connected to the terminal device, e.g., the CPE.

In an embodiment, conducting the evaluation of the signal is processed at a network management system, and the network management system is connected to a first access node that supplies a first access service. A first terminal of the switch is connected to the first access node, and the network management system is also connected to a second access node that supplies a second access service. A second terminal of the switch is connected towards the second access node, and the switch is arranged to connect either one of the first or second terminal to the terminal device. The network management system is arranged for controlling the first access node to control the switch.

For example, the network management system may instruct the first access node to control the switching state of the switch, e.g., to connect either the first or the second access node towards the terminal device.

In an embodiment, the first access node is a distribution point unit.

In an embodiment, the first access node supplies a G.fast service.

In an embodiment, the second access node is a DSLAM, which in particular provides an xDSL service.

Also, a system is suggested that comprises a first access node providing a first access service via a migration unit. The system also comprises a migration unit and a second access node providing a second access service via the migration unit. The migration unit comprises a switch that is arranged to connect one of the access services with a subscriber line that is connected or connectable to a terminal device. The first access node is arranged to conduct an evaluation of a signal obtained via the subscriber line and to control the switch based on the evaluation of the signal.

The signal may be provided by the terminal device that is connected to the subscriber line.

It is noted that the access service may be provided to the terminal device (e.g., CPE or subscriber) via the migration unit. The access service is not terminated at the migration unit, but it is conveyed towards the terminal device.

It is noted that the migration unit may be separate or part of one of the access nodes. The migration unit may in particular be part of the first access node that controls the switch.

The signal may be a signal of a handshake process.

In an embodiment, the signal obtained via the subscriber line is a signal of a handshake process between the terminal device and one of the access nodes, wherein the first access node is arranged to control the switch such that the access service is selected that corresponds to the signal of the handshake process.

In an embodiment, the first access node is arranged to control the switch such that its switching state is changed in case conducting the evaluation of the signal did not reveal an access service to be selected.

Further, a system is provided that comprises a first access node providing a first access service to a migration unit. The system also comprises a migration unit and a second access node providing a second access service to the migration unit. The migration unit comprises a switch that is arranged to connect one of the access services with a subscriber line that is connected or connectable to a terminal device. The system further comprises a network management system that is connected to the first access node and to the second access node. The network management system is arranged to conduct an evaluation of a signal obtained via the subscriber line and to control the first access node to control the switch based on the evaluation of the signal.

The evaluation of the signal may be done at the DSLAM/DPU with or without the existence of an NMS. However, in this example, the evaluation of the extracted capabilities is done in the NMS. It is noted that the signal may be or comprise an information that is subject to the evaluation of the NMS.

In an embodiment, the signal obtained via the subscriber line is a signal of a handshake process between the terminal device and one of the access nodes, wherein the network management system is arranged to control the first access node such that the switch is controlled such that the access service is selected that corresponds to the signal of the handshake process.

In an embodiment, the network management system is arranged to control the first access node such that the switch is controlled such that its switching state is changed in case conducting the evaluation of the signal did not reveal an access service to be selected.

A computer program product is suggested, that is directly loadable into a memory of a digital processing device, comprising software code portions for performing the steps of the method as described herein.

A computer-readable medium is provided, which has computer-executable instructions adapted to cause a computer system to perform the steps of the method as described herein.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those cases in which this has not explicitly been mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims.

### LIST OF ABBREVIATIONS

ADSL Asymmetric DSL
AN Access Node
CO Central Office
CPE Customer Premises Equipment
DPU Distribution Point Unit
DSL Digital Subscriber Line
DSLAM DSL Access Multiplexer
FTTB Fiber to the Building
FTTC Fiber to the Cabinet
FTTDP Fiber to the Distribution Point
G.fast Fast Access to Subscriber Terminals
MSAN Multi Service Access Node
POTS Plain Old Telephone Service
VDSL Very high Speed DSL
xDSL ADSL, VDSL or any other G.99x.y type DSL service

1. A method for switching a subscriber line comprising:
conducting an evaluation of a signal provided by a terminal device; and
controlling a switch that is arranged to connect one of at least two access services based on the evaluation of the signal with the subscriber line that is connected to the terminal device.

2. The method according to claim 1, wherein the terminal device is a customer premises equipment.

3. The method according to claim 1, wherein one of the at least two access services is a G.fast service.

4. The method according to claim 1, wherein one of the at least two access services is an xDSL service.

5. The method according to claim 1, wherein the signal provided by the terminal device is a signal of a handshake process between the terminal device and a device supplying one of the at least two access services.

6. The method according to claim 5, wherein the signal of the handshake process identifies the access service and the switch is controlled such that the access service is selected that corresponds to the signal of the handshake process.

7. The method according to claim 1, wherein the switch is controlled such that it changes its current switching state in case conducting the evaluation of the signal did not reveal an access service to be selected.

8. The method according to claim 1, wherein conducting the evaluation of the signal is processed at a first access node that supplies a first access service.

9. The method according to claim 8, wherein the switch is bypassed via a handshake filter that is connected to a terminal of the switch that is connected to the first access node and wherein the first access node is arranged to conduct the evaluation of the signal based on the output provided by the handshake filter.

10. The method according to claim 9, wherein at least one additional terminal of the switch is connected towards a second access node, wherein the switch is arranged to be switched between the terminal and the additional terminal.

11. The method according to claim 10, wherein the first access node is a distribution point unit.

12. The method according to claim 11, wherein the first access node supplies a G.fast service.

13. The method according to claim 10, wherein the second access node is a DSLAM, which in particular provides an xDSL service.

14. The method according to claim 8, wherein the first access node is arranged to control the switch.

15. The method according to claim 1, wherein conducting the evaluation of the signal is processed at a network management system, wherein the network management system is connected to a first access node that supplies a first access service, wherein a first terminal of the switch is connected to the first access node, wherein the network management system is also connected to a second access node that supplies a second access service, wherein a second terminal of the switch is connected towards the second access node, wherein the switch is arranged to connect either one of the first or second terminal to the terminal device, and wherein the network management system is arranged for controlling the first access node to control the switch.

16. The method according to claim 15, wherein the first access node is a distribution point unit.

17. The method according to claim 16, wherein the first access node supplies a G.fast service.

18. The method according to claim 15, wherein the second access node is a DSLAM, which provides an xDSL service.

19. A system comprising:
a first access node providing a first access service via a migration unit;
a second access node providing a second access service via the migration unit; and
the migration unit, wherein the migration unit comprises a switch that is arranged to connect one of the access services with a subscriber line that is connected or connectable to a terminal device, and wherein the first access node is arranged to conduct an evaluation of a signal obtained via the subscriber line and to control the switch based on the evaluation of the signal.

20. The system according to claim 19, wherein the signal obtained via the subscriber line is a signal of a handshake process between the terminal device and one of the access nodes, and wherein the first access node is arranged to control the switch such that the access service is selected that corresponds to the signal of the handshake process.

21. The system according to claim 19, wherein the first access node is arranged to control the switch such that its switching state is changed in case conducting the evaluation of the signal did not reveal an access service to be selected.

22. A system comprising:
a migration unit;
a first access node providing a first access service to the migration unit;
a second access node providing a second access service to the migration unit, wherein the migration unit comprises a switch that is arranged to connect one of the access services with a subscriber line that is connected or connectable to a terminal device; and
a network management system that is connected to the first access node and to the second access node, wherein the network management system is arranged to conduct an evaluation of a signal obtained via the subscriber line and to control the first access node to control the switch based on the evaluation of the signal.

23. The system according to claim 22, wherein the signal obtained via the subscriber line is a signal of a handshake process between the terminal device and one of the access nodes, and wherein the network management system is arranged to control the first access node such that the switch is controlled such that the access service is selected that corresponds to the signal of the handshake process.

24. The system according to claim 22, wherein the network management system is arranged to control the first access node such that the switch is controlled such that its switching state is changed in case conducting the evaluation of the signal did not reveal an access service to be selected.
